(19) United States
(12) Patent Application Publication
(10) Pub. No.: US 2009/0188899 A1
(43) Pub. Date: Jul. 30, 2009

(54) METHOD AND DEVICE FOR PREVENTIVE TREATMENT OF AN OPTICAL SURFACE DESIGNED TO BE EXPOSED TO A LASER FLUX

(75) Inventors: Philippe Bouchut, Voreppe (FR); Jean-Guillaume Coutard, Grenoble (FR); Annelise During, Talence (FR)

Correspondence Address: BRINKS HOFER GILSON & LIONE, P.O. BOX 10395, CHICAGO, IL, 60610, US

(73) Assignee: COMMISSARIAT A A'ENERGIE ATOMIQUE, Paris (FR)

(21) Appl. No.: 12/161,796

(22) PCT Filed: Jan. 26, 2007
(86) PCT No.: PCT/FR2007/000155

§ 371 Date: Jul. 22, 2008

(30) Foreign Application Priority Data
Jan. 27, 2006 (FR) 0650302

(51) Int. Cl. B23K 26/42; G02B 1/12

(52) U.S. Cl. 219/121.61; 219/121.66

(57) ABSTRACT

A device for preventive treatment of an optical surface designed to be exposed to a laser flow including a thermal excitation source for providing a localized thermal annealing of a site of the optical surface) by means of a beam applied to the site. The device further includes a measuring member for measuring, in real time said during said localized thermal annealing, a quantity representing the temperature of the site of the optical surface) and at least one control member for increasing the linear power density of the beam applied to the site by the excitation source and, when the quantity reaches a predetermined set point, for gradually decreasing the linear power density.

### PRIORITY CLAIM

This application is a U.S. nationalization of PCT Application No. PCT/FR2007/000155, filed Jan. 26, 2007, and claims priority to French Patent Application No. 0650302, filed Jan. 27, 2006.

### TECHNICAL FIELD

The present invention relates to preventive treatment of an optical surface designed to be exposed to a laser flux. It finds a general application in the field of optics and more particularly in strengthening the laser flux resistance of optical surfaces.

### BACKGROUND

In French patent application 0412304 filed 19 Nov. 2004 and in the corresponding application WO 2006/053959 published 26 May 2006, the Applicant has described the fact that damaged areas can appear on the surface of the optical components of a laser system on which a high laser flux impinges. In practice, the size of such damaged areas increases exponentially on subsequent laser firings. Optical functionality is therefore degraded over an increasingly large area and, as a result of optical propagation, the damage can even cause damage to other optical components of the laser system. The energy of the laser beam is then no longer transported under nominal conditions. The appearance of such laser damage on the surface of optical components impacts on the service life of the optical components and on laser system maintenance costs.

### SUMMARY

The present invention remedies these drawbacks.

It relates to a device for preventive treatment of an optical surface designed to be exposed to a laser flux, said device comprising a thermal excitation source for localized thermal annealing of a site of said surface to be treated by means of a beam applied to said site, characterized in that it further comprises a measuring member for measuring, in real time during said localized thermal annealing, a quantity representing the temperature of the site of the optical surface to be treated and at least one control member for increasing the linear power density of the beam applied to the site by the excitation source and, when said quantity has reached a predetermined set point, for gradually decreasing said linear power density (it is therefore no longer a question of simple cancellation of that linear power density).

Such devices have the advantage that they can impose modification of the regime of variation (raising then lowering) of the linear power density applied to the site on the optical surface to be treated as a function of a quantity representing the temperature of the site on the optical surface to be treated, and therefore controlled in real time during thermal annealing of the optical surface to be treated, which enables annealing adapted to the optical surface to be treated, without having to know all its characteristics.

In one embodiment the excitation source is a continuous laser, for example a continuous CO₂ laser, or a modulated continuous laser, for example a modulated continuous CO₂ laser. In fact, a modulated continuous laser can have the same average power as a “simple” continuous laser, but additionally with amplitude and/or frequency modulation, for example +/−20% modulation at 1 kHz. This applies also to the laser beams obtained. In fact, since most current continuous lasers can be modulated, the same laser can operate in a totally continuous (constant) mode or in a modulated continuous mode.

In another embodiment, the member for measuring the quantity representing the temperature of the site of the optical surface to be treated is of the thermoluminescence sensor type.

In one embodiment, the control member includes a motor for displacing a focusing lens situated between the thermal excitation source and the surface to be treated.

For example, the material of the optical surface to be treated is silica.

The present invention also relates to a method for preventive treatment of an optical surface designed to be exposed to a laser flux, said treatment comprising a step of localized thermal annealing of a site of said surface to be treated by means of a beam generated by means of a thermal excitation source, characterized in that there is measured in real time during said localized thermal annealing a quantity representing the temperature of the site of the optical surface to be treated and initially the linear power density of the beam applied to the site by means of the thermal excitation source is increased and, when said quantity reaches a predetermined set point (NC), said linear power density is gradually decreased.

The beam is advantageously continuous, notably constant or modulated.

The linear power density is advantageously decreased more slowly than the previous increase of that linear power density. The average slope of the increasing linear power density is preferably in a ratio of at least 10/1 to the average slope of the decreasing linear power density.

The measurement of said quantity is advantageously of the thermoluminescence measurement type.

The increase in the linear power density is equally advantageously caused by reducing the characteristic radius of the beam applied to the site of the surface to be treated while maintaining the beam emission power constant.

The increase in the linear power density is advantageously preceded by opening a shutter allowing the beam emitted by the thermal excitation source to pass.

The decrease in the linear power density is equally advantageously caused by reducing the power of the beam at constant beam characteristic radius.

When the crossing of a second set point is detected when decreasing the linear power density, a new regime of variation of that linear power density is equally advantageously started; this new regime of variation of the linear power density corresponds to virtually instantaneous cancellation. This is therefore not a gradual decrease.

### BRIEF DESCRIPTION OF THE DRAWING

Features and advantages of the invention will appear in the light of the detailed description and the drawings, in which:

FIG. 1 is a curve illustrating a thermal annealing cycle obtained by chaining a number of modifications made to the linear power density of the excitation source;

FIG. 2 represents curves illustrating three successive thermal annealing cycles applied to the same site until the same chosen thermoluminescence set point is reached;

FIG. 3 represents curves illustrating the temporal tracking of a thermal annealing cycle applied to two different sites;

FIG. 4 represents diagrammatically the essential elements of the preventive treatment device of the invention; and

FIG. 5 is a curve illustrating the evolution of the characteristic radius of the laser beam on the optical component as a function of the axial coordinate of the focusing lens of the device of the invention.

### DETAILED DESCRIPTION

Generally speaking, the preventive treatment method of the invention is based on imposing a modification of the regime of linear power density variation (increase then decrease) applied to a site (or localized area) to be treated on the optical surface when a quantity representing the temperature of the site to which the beam is applied reaches a set point, which is tracked in real time during thermal annealing of the surface to be treated. The thermal treatment is localized since the incident beam intercepts only a portion of the surface of the optical component. These sites can be identified by a diagnosis as described in the aforementioned document WO-2006/053959.

The linear power density is defined as the laser power absorbed by the material at the site divided by the characteristic radius r of the laser beam at the site. The characteristic radius r is a representative dimensional parameter of the laser beam. For a Gaussian mode laser beam, it is defined as the waist radius at 1/e² of the maximum intensity.

The rise in temperature ΔT at the centre of a laser beam of linear power density Pₗ at a site of apparent thermal conductivity C is. The Applicant has observed that the app

$$Δ T ∝ \frac{{P}_{I}}{C}$$

thermal conductivity of the standard optical materials increases with the temperature T according to an a priori “indeterminate” law depending on the site. In this context, it is not always possible to reach a set point ΔT if the linear power density Pₗ is predefined and constant. However, the Applicant has observed that it is possible to reach the set point ΔT if the linear power density of the excitation laser increases when increasing the temperature to compensate the increase of thermal conductivity with temperature. Conversely, when decreasing the temperature, the Applicant has observed that it is possible to reach the set point temperature if the linear power density decreases to compensate the decrease in the apparent thermal conductivity.

The evolution of the surface temperature field of a site can advantageously be tracked in real time by means of a thermoluminescence or incandescence diagnosis.

The Applicant has also observed that real time tracking of the thermoluminescence enables one or more set point values NC to be established for which it is beneficial to change the regime of variation of the linear power density Pₗ reaching the site.

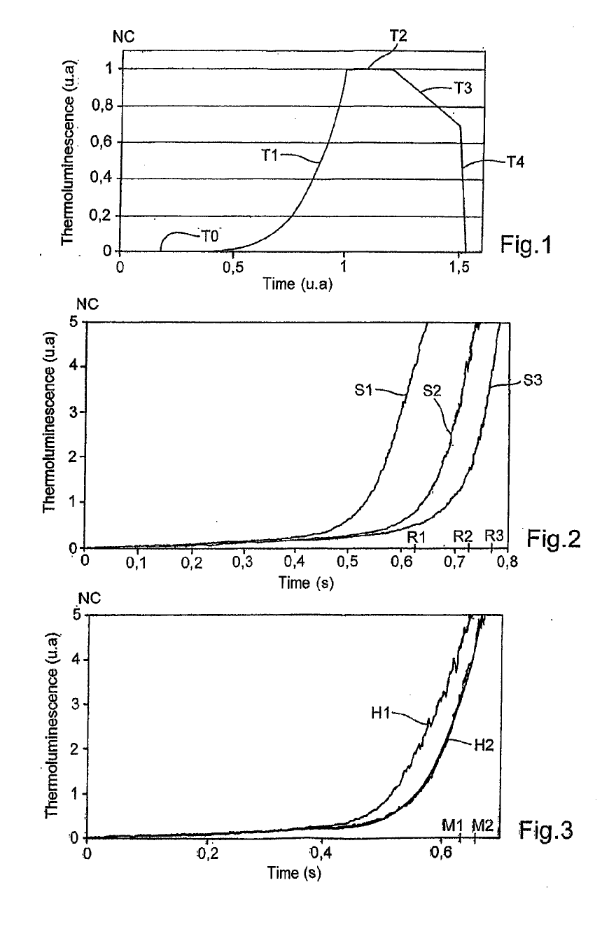

FIG. 1 represents the chaining of a number of modifications of the regime of variation of the linear power density to create a thermal annealing cycle.

For example, at the time t=0, opening a shutter increases the linear power density from zero to a linear power density Pₗ (section T0 of the curve). Synchronized with this opening, reduction of the characteristic radius of the excitation laser beam impinging on the optical component is started, which, at fixed laser power, increases the incident linear power density and the temperature at the site. The reduction of the characteristic radius is halted when the set point thermoluminescence level NC=1 (NC being measured in arbitrary units) is reached (section T1 of the curve). At this set point level NC=1, there is in practice a latency time in which the linear power density does not evolve (section T2 of the curve), after which the linear power density is decreased by reducing the laser power, keeping the characteristic radius fixed, which reduces the temperature at the site (section T3 of the curve). This decrease is accentuated when the set point level NC=0.7 is reached and the shutter is closed, reducing the linear power density to zero virtually instantaneously, which enables the temperature to return to room temperature faster (section T4 of the curve).

It should be noted that the slope of the decreasing portion is lower than the slope of the increasing portion; in other words, the decrease is slower than the increase. The decrease is advantageously slower by a factor of at least 10 (i.e. the slope of the increasing portion is at least 20 times the slope (in absolute value) of the decreasing portion). Of course, the slope concept corresponds to average slopes, because the increasing and decreasing portions are not necessarily linear, as is clear from FIG. 1.

For example, the level NC can be set in accordance with the following reasoning. For the annealing of the surface to be treated to take place, the maximum temperature Tₘₐₓ reached by that surface must be such that the material of the surface is in a “glass transition” state; for example, if the material is silica, it is necessary for Tₘₐₓ to be from 1200 K to 3000 K. Moreover, it is desirable to choose a temperature Tₘₐₓ that is not too high in order for the silica not to evaporate too much; the range for Tₘₐₓ can therefore reasonably be limited to 1200 K to 2200 K. It is nevertheless desirable for Tₘₐₓ not to be too low, to prevent the treatment taking too long: thus the range of choice for Tₘₐₓ can be restricted to 1700 K to 2200 K, for example (or even to around a value such as 2000 K).

The cycle described with reference to FIG. 1 can be modified at will. The thermoluminescence set points NC at which there is a change of regime, the levels NC=1 and NC=0.7 in FIG. 1, can also be adapted to the tested material given the thermoluminescence diagnosis used. The “time” parameter is free at each site.

In the preventive treatment method of the invention, the regime of variation of the linear power density is thus modified when the thermoluminescence tracked in real time during thermal annealing reaches a chosen set point value NC (increase then decrease when the threshold NC=1 is reached when increasing; progressive then sudden decrease when the threshold NC=0.7 is reached when decreasing). This kind of method therefore applies a complete thermal cycle, with the temperature raised and then lowered, at a localized site the intrinsic thermal properties and absorption properties whereof are not known.

In practice, the first regime of variation (increasing) of the linear power density reaches a temperature rise set point regardless of the apparent thermal conductivity C of the site to be annealed. If the thermal conductivity C is low, the necessary maximum linear power density will be low and the temperature rise set point will be reached faster given that the linear power density is increasing when the temperature is rising and decreasing when the temperature is falling.

In the method of the invention, thermal annealing is monitored continuously by the thermoluminescence diagnosis, for example, which ensures that the process can be adapted to each site by way of the “time” parameter.

FIG. 2 represents successive laser cycles or “firings” at the same site. The linear power density increases up to the level set point NC=5 and the shutter is closed. As the laser cycles S1 to S3 proceed, the set point level NC=5 is reached for an increasingly long time R: R3>R2>R1. The successive laser cycles show that the thermal cycle modifies the properties of the site because the thermoluminescence evolves from one cycle to another.

Another advantage of the preventive treatment method of the invention is flexibility. Thus the cycle shown by way of example in FIG. 1, with two set point levels NC, can be made more complex or simpler by fixing the number of thermoluminescence set point levels at which a change of the regime of variation of the linear power density can take place. There can even be plateaus or latency times (intentional or unintentional).

In practice, the laser power and the characteristic radius that cause the linear power density to evolve are two parameters that can evolve in separate phases of the cycle, as shown in FIG. 1 (i.e. with only one parameter varying at a time), or conjointly to adapt the regime of variation of linear power density.

By analogy, the Applicant has observed that when the method described above is modified to carry out etching to reduce existing damage in an amorphous material, by applying a single regime of variation of linear power density that is stopped when a thermoluminescence set point level NC is reached corresponding to a temperature higher than the softening point of the amorphous material, real time tracking of the temperature achieves better reproducibility of the etching depth in the material than in the past.

FIG. 3 represents the tracking in time by thermoluminescence diagnosis of this kind of thermal cycle applied to two sites (curves H1 and H2). At time t=0, the shutter opens and the waist diameter of the excitation laser beam decreases, thereby increasing the linear power density applied to the site. When the set point luminescence level NC=5 is reached, the shutter is closed and the linear power density falls to zero.

FIG. 3 shows that the blocking of the beam occurs at a different time M corresponding to a different linear power density between the two sites (M1<M2). The Applicant has observed that over eleven sites tested, with a step of 2 mm, and with a thermoluminescence set point NC=5 u.a (arbitrary units), the etching depth obtained is 9.8 μm with a dispersion of plus or minus 2.5%. This is a significant improvement over the document “Localized silica re-fusion for laser damage mitigation”; P. Bouchut, L. Delrive, D. Decruppe, P. Garrec, Proc. of SPIE vol 5273, p 250-257 (2004), in which annealing (and etching) of the sites is effected at constant linear power density and the etching depth dispersion reaches 50%. This shows that adapting the linear power density applied to each site as a function of the tracked temperature, in accordance with one feature of the invention, reduces the thermal annealing dispersion affecting the various sites.

In fact, in an annealing cycle applied to amorphous materials, such as glass or fused silica, it is known that the cooling is the most critical part. This is the case in particular when the material becomes rigid again, in the temperature range above and slightly below the deformation temperature. If cooling is too fast, permanent stress can appear and cause fracture of the material if it is too high. Slow cooling allows all points of the site to cool at the same rate and therefore minimizes the residual stress. Thanks to the method of the invention, this slow cooling is controlled by the rate of decrease of the excitation linear power density until the thermoluminescence decreases to the required set point level. Note that this slow cooling is not possible with a purely ablative method.

If the characteristic radius r of the laser beam changes over time, not only does the incident linear power density evolve in inverse proportion, but the characteristic interaction time evolves in accordance with a square law, since, where D is the thermal diffusivity of the material. The reduction of the characteristic radius r at constant las

$$τ ∝ \frac{{r}^{2}}{D} N$$

er consequently accelerates the rise in temperature at the centre of the laser beam. This is useful for minimizing the interaction time when raising the temperature at the site and therefore reduces the energy deposited at the site. If the temperature exceeds the so-called annealing temperature in an amorphous material and evaporation of the material occurs, the ablation that results is slow because it is on the scale of the characteristic interaction time.

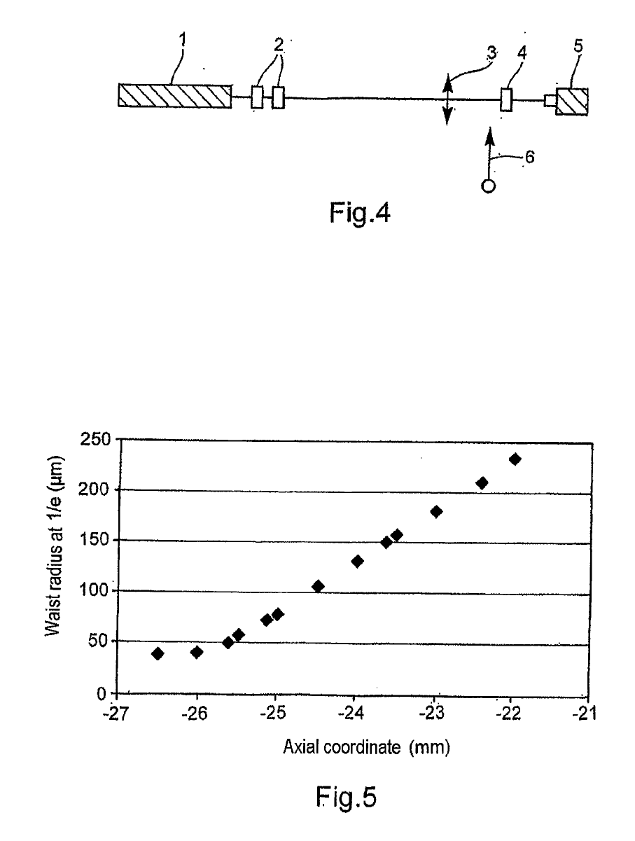

FIG. 4 shows a laser system for implementing the preventive method of the invention.

For example, a continuous CO₂ laser 1 constitutes an excitation source for effecting the thermal annealing. The emission wavelength of the laser 1 is 10.59 μm, for example, which corresponds to the most powerful laser emission line. The excitation wavelength is adapted to the optical material to be annealed: thermal annealing is possible only if there is a rise in temperature of the optical material. It is therefore indispensable for some or all of the emission spectrum of the excitation source to correspond to the absorption spectrum of the tested material.

In silica, for example, all emission lines of the CO₂ laser, from 9.2 to 10.8 μm, can be used. The power stability of the excitation source 1 is good: typically plus or minus 1%, minimum to maximum, over the annealing time. The laser emission mode can be of any kind (Gaussian, flat, annular, etc.) but must be at least approximately stable.

Finally, the power needed to effect the annealing is a linear power density that depends on the dimension of the site to be annealed, typically less than 20 watts if the dimension is smaller than 1 mm. The annealing source 1 can be any other laser source, lamp, black body the spectral emission whereof is wholly or partly absorbed by the material under test. It can also be an electron beam generator.

Here the device implementing the invention further comprises a device 2 for monitoring and stabilizing the power of the laser. The device 2 comprises, for example, a number of elements: a laser power controller, which can consist of a half-wave plate followed by a polarizer. This kind of controller adjusts the excitation power and thus contributes (on its own or in combination with other elements) to varying the linear power density applied to the site to be annealed. The device 2 can also be complemented by a shutter for allowing the laser beam to pass or blocking it. The device 2 can also include a device for real time stabilization of the power of the annealing laser. Alternatively, the shutter can be replaced by a device for “on-off” switching of the laser source 1 itself. Clearly the combination of the elements 1 and 2 can also be treated as a thermal excitation source; it is therefore only by convention that it is stated that the elements 2 are external to the source, or on the contrary internal to it.

The device implementing the invention advantageously further comprises a focusing lens 3, for example of ZnSe with anti-reflection treatment at the wavelength of the annealing laser, and the focal length is adapted to the focal spot to be obtained on the component to be treated. The size of the focal spot at the surface of the sample can be determined by the knife method. Alternatively, a nozzle for feeding gases beneficial to the process such as oxygen, argon, compressed air, etc., or for aspirating emitted vapors, can be fastened to the focusing lens.

In practice, the surface of the optical component 4 to be tested faces the incident laser beam. The method of the invention is well adapted to optical materials of low thermal conductivity, typically less than 10 W/(m.K), which have a higher local temperature increase for a given incident linear power density. Materials such as fused silica, all types of glass and laser crystals, doped or undoped, and materials such as KDP, used for frequency conversion, are materials to which the method of the invention can be adapted.

A photometry device 5 is provided to collect photons emitted by the thermoluminescent area in the situation considered here; it is therefore a thermoluminescence sensor. In the FIG. 4 optical diagram, the photometry device 5 is downstream of the sample 4 under test. This arrangement has the advantage of filtering excitation photons since silica absorbs radiation at 10.59 μm and detection can take place in the range of transparency of silica, i.e. at a wavelength between 0.2 and 4 μm, which provides scope for many types of sensor (photomultiplier, silicon, InGaAs, PbSe, HgCdTe, etc.) in single-element or camera form. Alternatively, the photometry device 5 can be placed anywhere else except where it would intercept the excitation beam. The advantage of placing the photometry device upstream of the sample 4 is that this benefits from a detection spectral range extending to the far infrared. The magnification of the zoom that images the thermoluminescent area on the sensor 5 must be adapted both to the dimension of the annealed area (i.e. of the site in question) and the spatial resolution of the photometry sensor.

This device 5, capable of measuring a quantity representing the temperature at the site, is connected to at least one control member, here shown diagrammatically at 6, to cause a change of regime of variation of linear power density applied to the site.

The variation of the annealing linear power density in each regime is provided here by two motors 6 that can be energized individually or conjointly. The first motor rotates the half-wave plate 2 to vary the power transmitted through one or more fixed polarizers. The second motor 6 moves the focusing lens 3 in translation along the optical axis Z of the system. The size of the characteristic radius r at the optical component 4, as a function of the coordinate Z of the focusing lens 3, is established by the knife method. This kind of graph, in the case of a Gaussian beam, is shown in FIG. 5, where the characteristic dimension of the laser beam at the optical component 4 evolves with the displacement of the focusing lens 3. It is thus possible to vary the linear power density arriving at a given site by moving the focusing lens 3 in translation at constant emitted power.

The method of the invention can be used to condition a damage precursor site or to stabilize damage to an optical component. This enables integration into the optical system of components having potential or proven defects in terms of laser flux resistance. At this time, it has not been proven that zero defect optical components exist and a method of the invention is therefore useful and necessary for all large-area optical components with a high specification in terms of laser flux resistance. Furthermore, the method of the invention can achieve great savings in terms of maintenance and the service life of the components of high-power laser systems.

The method of the invention can also be used for thermal conditioning of more complex optical components such as multilayer dielectric mirrors where the area of laser flux resistance does not exceed a few mm².

1. A device for preventive treatment of an optical surface configured for exposure to a laser flux, the device comprising:
a thermal excitation source for localized thermal annealing of a site of the optical surface by means of a beam applied to the sites;
a measuring member for measuring, in real time during the localized thermal annealing, a quantity representing the temperature of the site of the optical surface; and
at least one control member for increasing the linear power density of the beam applied to the site by the excitation source and, when said quantity has reached a predetermined set point, for gradually decreasing said linear power density.

2. The device according to claim 1, wherein the thermal excitation source comprises a laser.

3. The device according to claim 2, wherein the laser comprises a continuous CO₂ laser.

4. The device according to claim 1, wherein the measuring member comprises a thermoluminescence type sensor.

5. The device according to claim 1, wherein the control member includes a motor for displacing a focusing lens situated between the thermal excitation source and the optical surface.

6. The device according to claim 1, wherein the material of the optical surface comprises silica.

7. A method for preventive treatment of an optical surface configured for exposure to a laser flux, the treatment comprising:
a step of localized thermal annealing of a site of the optical surface by means of a beam generated by means of a thermal excitation source, and furthering comprising,
measuring a quantity representing the temperature of the site of the optical surface in real time during the localized thermal annealing, and initially increasing the linear power density of the beam and, when the quantity reaches a predetermined set point, gradual decreasing the linear power density.

8. The method according to claim 7, wherein the linear power density is decreased more slowly than the previous increase of the linear power density.

9. The method according to claim 8, wherein an average slope of the increasing linear power density is in a ratio of at least 10/1 to an average slope of the decreasing the linear power density.

10. The method according to claim 7, wherein measuring a quantity comprises a thermoluminescence measurements.

11. The method according to claim 7, wherein increasing the linear power density comprises reducing the characteristic radius of the beam applied to the site of the surface to be treated while maintaining a constant beam emission power.

12. The method according to claim 7, further comprising opening a shutter allowing the beam emitted by the thermal excitation source to pass prior to increasing the linear power density.

13. The method according to claim 7, wherein decreasing the linear power density comprises reducing the power of the beam at a constant characteristic beam radius.

14. The method according to claim 7, further comprising commencing a new regime of variation of linear power density when the crossing of a second set point is detected when decreasing the linear power density.

15. The method according to claim 14, wherein the new regime of variation of the linear power density corresponds to virtually instantaneous cancellation.
